(19) United States
(12) Patent Application Publication
(10) Pub. No.: US 2017/0072622 A1
(43) Pub. Date: Mar. 16, 2017

(54) TEMPLATE PRODUCING METHOD, TEMPLATE PRODUCING APPARATUS AND TEMPLATE INSPECTING APPARATUS

(71) Applicant: KABUSHIKI KAISHA TOSHIBA, Tokyo (JP)

(72) Inventor: Seiji MORITA, Tokyo (JP)

(21) Appl. No.: 15/066,461

(22) Filed: Mar. 10, 2016

(30) Foreign Application Priority Data
Sep. 11, 2015 (JP) 2015-179753

(51) Int. Cl. B29C 65/48; G06T 7/00; B29C 44/02; B29C 59/02; B29C 55/02

(52) U.S. Cl. CPC B29C 65/48; B29C 59/02; B29C 55/02; B29C 44/02; G06T 7/001; G06T 7/0044; B29K 2105/0002

(57) ABSTRACT

In one embodiment, a template producing method includes coating a first template having a first pattern with a curable material, and curing the material. The method further includes producing a second template having a second pattern corresponding to the first pattern by peeling the cured material from the first template. The method further includes enlarging the second template, and pasting, on the enlarged second template, a substrate that holds a shape of the second template.

### CROSS REFERENCE TO RELATED APPLICATION

This application is based upon and claims the benefit of priority from the prior Japanese Patent Application No. 2015-179753, filed on Sep. 11, 2015, the entire contents of which are incorporated herein by reference.

### FIELD

Embodiments described herein relate to a template producing method, a template producing apparatus and a template inspecting apparatus.

### BACKGROUND

Optical nanoimprinting is known as a technique for forming a fine pattern at low costs. When a roughness pattern (concave-convex pattern) is to be formed on a substrate by the optical nanoimprinting, a template having the roughness pattern is prepared, the template is pressed onto a photocurable layer on the substrate, the photocurable layer is irradiated with light to cure the photocurable layer, and the template is released from the photocurable layer. This makes it possible to transfer the roughness pattern to the photocurable layer on the substrate.

However, when a defect is present on a surface of the template, the defect is also transferred to a surface of the substrate. Therefore, defect inspection of the template is often performed. For example, the defect inspection of the template is performed by using short wavelength laser (e.g., solid SHG laser with 193 nm of wavelength). In this case, the size of a detectable defect is limited to approximately 20 nm due to the limit of optical resolution, so that the defect whose size is smaller than this size cannot be detected.

Therefore, a method of inspecting the defect of the template is known, which transfers the roughness pattern of the template to a material that can be enlarged to produce a template duplicate, enlarges the template duplicate, and inspects the defect of the enlarged template duplicate. This makes it possible to enlarge the defect whose size is smaller than 20 nm and to detect the enlarged defect. However, if the shape of the template duplicate is distorted in this case due to the enlargement, it becomes difficult to inspect the defect in high precision.

### BRIEF DESCRIPTION OF THE DRAWINGS

FIG. 1 is a perspective view schematically illustrating a template producing method of a first embodiment;

FIGS. 2A to 3C are cross-sectional views illustrating the template producing method of the first embodiment;

FIGS. 4A to 5B are cross-sectional views illustrating operation of a template producing apparatus of the first embodiment;

FIGS. 6A and 6B are plan views illustrating a structure of the template producing apparatus of the first embodiment;

FIG. 7 is a perspective view schematically illustrating a structure of a template inspecting apparatus of the first embodiment;

FIG. 8 is a flowchart illustrating a template inspecting method of the first embodiment;

FIG. 9 is a cross-sectional view illustrating a structure of a template duplicate of the first embodiment;

FIG. 10 is a cross-sectional view illustrating a structure of a template duplicate of a second embodiment;

FIG. 11 is a graph for explaining a template duplicate of a third embodiment; and

FIG. 12 is a schematic diagram for explaining a template duplicate of a fourth embodiment.

### DETAILED DESCRIPTION

Embodiments will now be explained with reference to the accompanying drawings.

In one embodiment, a template producing method includes coating a first template having a first pattern with a curable material, and curing the material. The method further includes producing a second template having a second pattern corresponding to the first pattern by peeling the cured material from the first template. The method further includes enlarging the second template, and pasting, on the enlarged second template, a substrate that holds a shape of the second template.

### First Embodiment

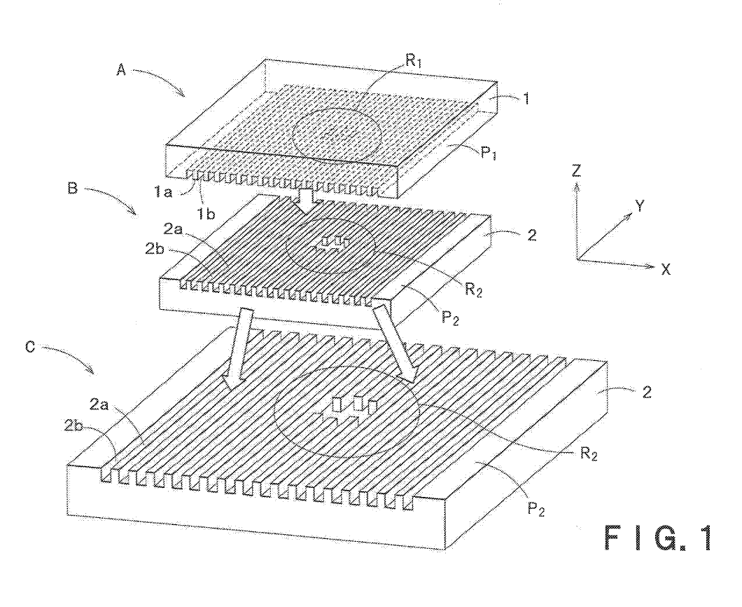

FIG. 1 is a perspective view schematically illustrating a template producing method of a first embodiment.

An arrow A indicates a template 1 having a first roughness pattern P₁. The template 1 of the present embodiment is used for optical nanoimprinting. For example, the template 1 is formed of quartz. The first roughness pattern P₁ alternately includes convex portions 1a and concave portions 1b. A defect R₁ arises on a surface of the template 1. For example, the size of the defect R₁ is nm or less. The template 1 is an example of a first template, and the first roughness pattern P₁ is an example of a first pattern.

An arrow B indicates a template duplicate 2 having a second roughness pattern P₂ corresponding to the first roughness pattern P₁. The template duplicate 2 of the present embodiment is produced by transferring the first roughness pattern P₁ onto a material that can be enlarged. Therefore, the second roughness pattern P₂ alternately includes convex portions 2a that correspond to the concave portions 1b and concave portions 2b that correspond to the convex portions 1a. Moreover, a defect R₂ that corresponds to the defect R₁ is transferred onto a surface of the template duplicate 2. The size of the defect R₂ is equal to the size of the defect R₁. The template duplicate 2 is an example of a second template, and the second roughness pattern P₂ is an example of a second pattern.

An arrow C indicates the template duplicate 2 that is enlarged after the production. FIG. 1 illustrates an X direction and a Y direction that are parallel to the surfaces of the template 1 and the template duplicate 2 and are perpendicular to each other, and a Z direction that is perpendicular to the surfaces of the template 1 and the template duplicate 2. The template duplicate 2 of the present embodiment is enlarged in the X direction and the Y direction. When the template duplicate 2 is enlarged, the second roughness pattern P₂ is enlarged and the defect R₂ is also enlarged. This makes it possible to optically detect the defect R₂. For example, the size of the enlarged defect R₂ is 25 nm or more.

In this specification, the +Z direction is regarded as the upward direction and the −Z direction is regarded as the downward direction. The −Z direction of the present embodiment may coincide with the direction of gravity or may not coincide with the direction of gravity.

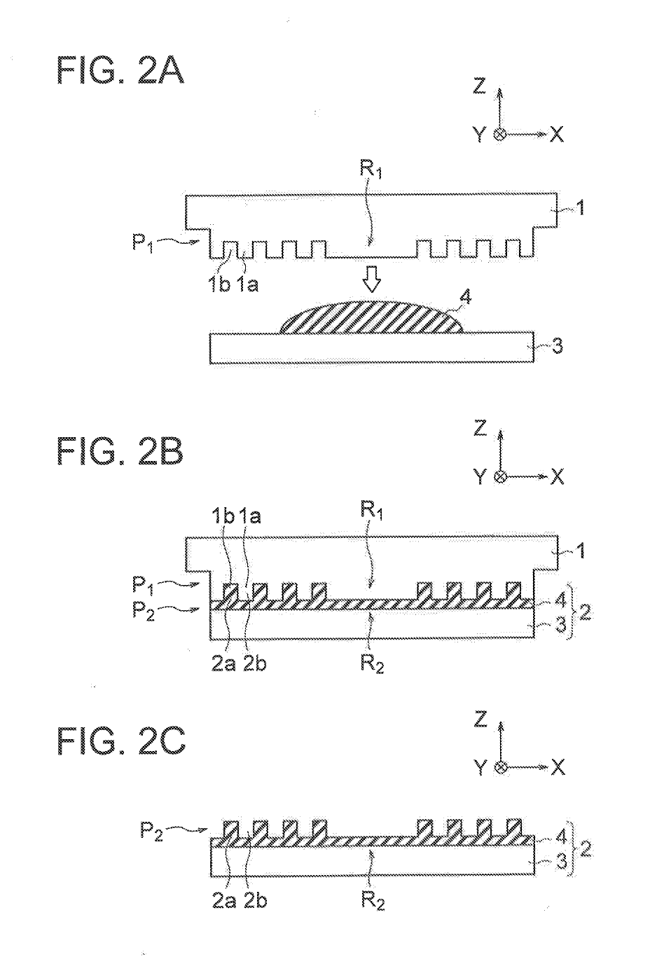

FIGS. 2A to 3C are cross-sectional views illustrating the template producing method of the first embodiment.

First, a resin material 4 is supplied onto a resin film 3 (FIG. 2A). Next, the first roughness pattern P₁ of the template 1 is pressed onto the resin material 4 (FIG. 2A). As a result, the template 1 is coated with the resin material 4. The resin of the resin film 3 is fluorine resin, for example. The resin of the resin material 4 is ultraviolet (UV) curable resin, for example. The resin material 4 is an example of a curable material.

Next, the resin material 4 is irradiated with ultraviolet rays to cure the resin material 4 (FIG. 2B). The cured resin material 4 is then peeled from the template 1 (FIG. 2C). As a result, the template duplicate 2 is produced to include the resin material 4 having the second roughness pattern P₂ and the resin film 3 pasted on the resin material 4. The resin material 4 is an example of a first layer. The resin film 3 is an example of a second layer.

Next, force is exerted on the resin film 3 to enlarge the template duplicate 2 (FIG. 3A). As a result, the second roughness pattern P₂ is enlarged and the defect R₂ is also enlarged.

Next, an adhesive 5 is supplied onto a substrate 6 (FIG. 3B). The substrate 6 is then pressed onto the enlarged template duplicate 2 (FIG. 3B). As a result, the substrate 6 is bonded to the template duplicate 2 with the adhesive 5. The adhesive 5 is a UV adhesive, for example. Therefore, when the substrate 6 is to be bonded to the template duplicate 2, the adhesive 5 is irradiated with ultraviolet rays. The substrate 6 is a glass substrate or a quartz substrate, for example.

The template duplicate 2 is formed of a material that is soft and can be enlarged. Therefore, when the template duplicate 2 is enlarged, the shape of the template duplicate 2 may be distorted. For this reason, the substrate 6 that holds the shape of the template duplicate 2 is pasted on the enlarged template duplicate 2 in the present embodiment. Since the substrate 6 is formed of a hard material, distortion of the template duplicate 2 can be corrected to secure the planarity of the template duplicate 2. In the present embodiment, the resin material 4 is pasted on one surface of the resin film 3, and the substrate 6 is pasted on the other surface of the resin film 3.

Next, the substrate 6 having the template duplicate 2 is pasted on a blank 7 (FIG. 3C). In the present embodiment, the defect R₂ of the template duplicate 2 can be inspected by putting the blank 7 on a stage of a template inspecting apparatus. If the substrate 6 can be put on the stage, the substrate 6 is not needed to be pasted on the blank 7.

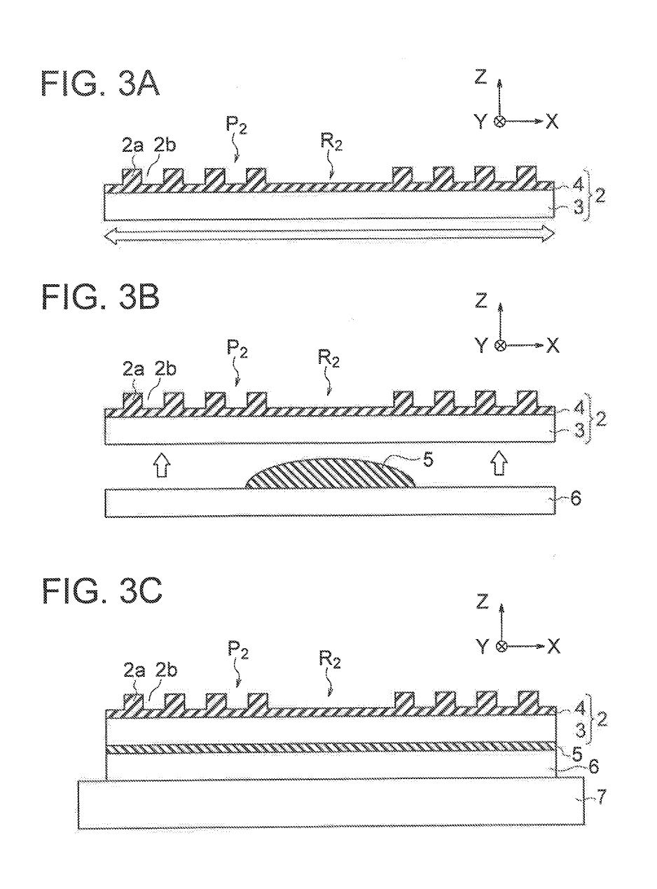

FIGS. 4A to 5B are cross-sectional views illustrating operation of a template producing apparatus of the first embodiment.

The template producing apparatus of the present embodiment includes a film retaining module 11, a template producing module 12, a substrate retaining module 13 and a controller 14 (FIG. 4A). The film retaining module 11 is an example of an enlarging module. The substrate retaining module 13 is an example of a pasting module.

The film retaining module 11 retains the resin film 3. The template producing module 12 produces the template duplicate 2 by using the resin film 3 retained by the film retaining module 11. Specifically, the template producing module 12 performs the steps in FIGS. 2A to 2C. The template producing module 12 includes a supplying module that supplies the resin material 4 onto the resin film 3, an irradiating module that irradiates the resin material 4 with ultraviolet rays, and a template driving module that presses the template 1 onto the resin material 4 and peels the resin material 4 from the template 1.

FIG. 4A illustrates the step in FIG. 3A performed by the film retaining module 11. FIG. 4B illustrates the step in FIG. 3B performed by the substrate retaining module 13. The film retaining module 11 exerts force on the resin film 3 to enlarge the template duplicate 2. The substrate retaining module 13 retains the substrate 6 to which the adhesive 5 is supplied, and presses the substrate 6 onto the enlarged template duplicate 2. At this time, the irradiating module of the template producing module 12 irradiates the adhesive 5 with ultraviolet rays. As a result, the substrate 6 is bonded to the template duplicate 2 that is in an enlarged state.

The operation of the film retaining module 11, the template producing module 12 and the substrate retaining module 13 is controlled by the controller 14.

Next, a trimming module 15 of the template producing apparatus trims the extra portion of the template duplicate 2 (FIG. 5A). The trimming module 15 of the present embodiment trims the template duplicate 2 by cutting the resin film 3. The operation of the trimming module 15 is controlled by the controller 14. FIG. 5B illustrates the template duplicate 2 after the trimming. The substrate 6 is then pasted on the blank 7.

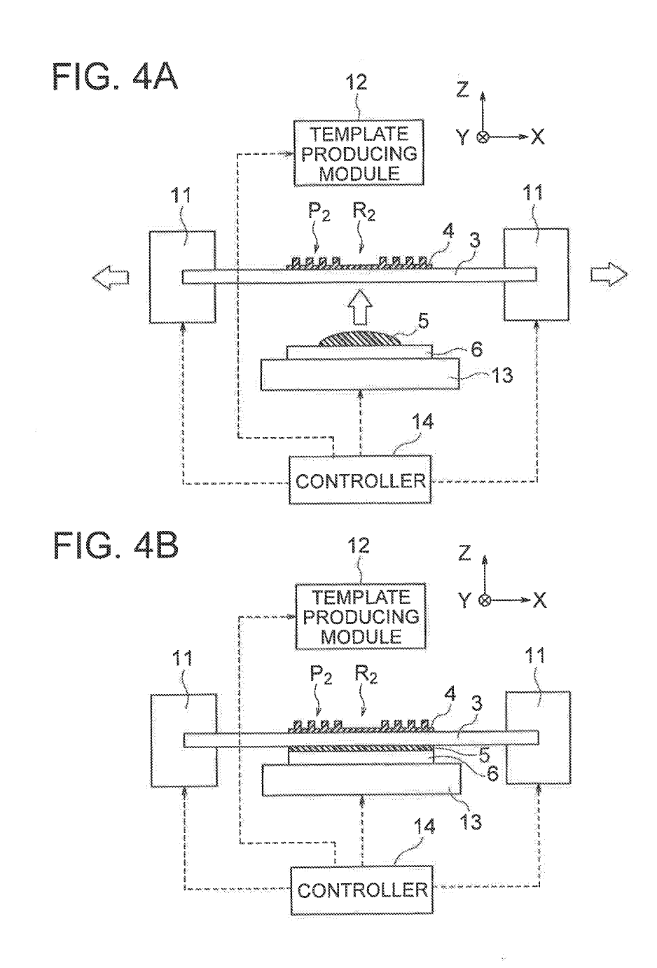

FIGS. 6A and 6B are plan views illustrating a structure of the template producing apparatus of the first embodiment.

FIG. 6A illustrates an example of the film retaining module 11. In this example, four film retaining modules 11 retain the four corners of the resin film 3. In this example, these film retaining modules 11 move in directions of 45 degrees, 135 degrees, 215 degrees and 305 degrees relative to the +X direction, so that the resin film 3 can be enlarged in the X direction and the Y direction.

The resin film 3 may have a spacer 3a on its outer circumference as illustrated in FIG. 6B. Thereby, the film retaining modules 11 can easily retain the resin film 3, which facilitates the resin film 3 to be easily enlarged.

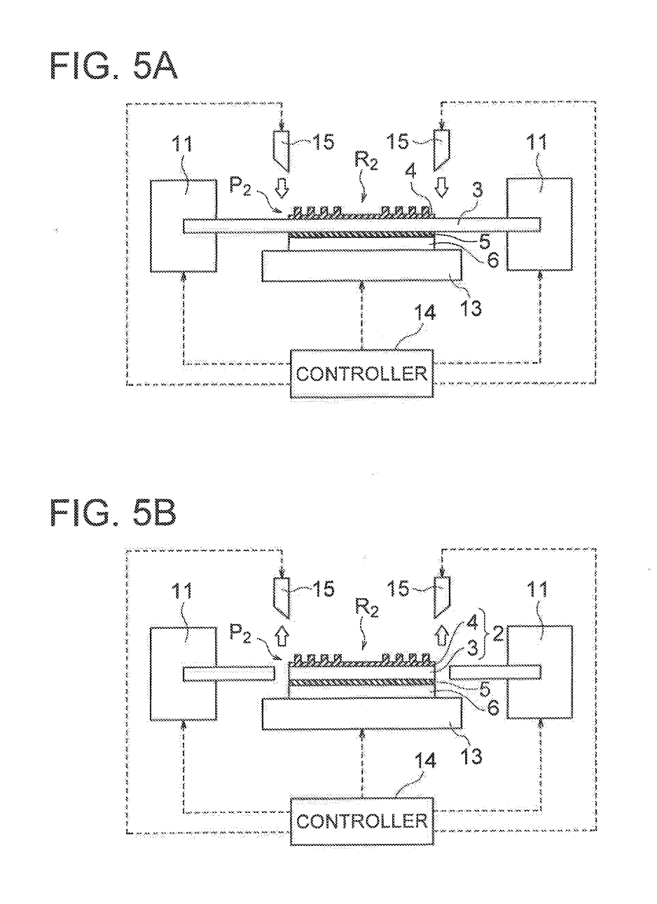

FIG. 7 is a perspective view schematically illustrating a structure of a template inspecting apparatus of the first embodiment.

The template inspecting apparatus of the present embodiment includes a light source 21, a condenser lens 22, an XY stage 23, an objective lens 24, an image sensor 25, a sensor circuit 26, an analog to digital (A/D) converter 27, a stage controlling circuit 28, a calculator 29 and a defect detecting circuit 30. The XY stage 23 and the stage controlling circuit 28 are an example of a retaining module. The image sensor 25, the sensor circuit 26 and the A/D converter 27 are an example of an imaging module. The defect detecting circuit 30 is an example of a magnification calculating module, a defect detecting module and a defect position calculating module.

Examples of the light source 21 include a mercury lamp and an argon laser light source. Light from the light source 21 is incident on the template duplicate 2 on the XY stage 23 through the condenser lens 22.

The XY stage 23 is configured to be able to retain the blank 7 illustrated in FIG. 3C. In the present embodiment, the defect R₂ of the template duplicate 2 can be inspected with the blank 7 put on the XY stage 23. If the substrate 6 can be put on the XY stage 23, the substrate 6 is not needed to be pasted on the blank 7. It is noted that illustration of the substrate 6 and the blank 7 is omitted in FIG. 7.

The XY stage 23 is configured to be able to move the template duplicate 2 in the X direction and the Y direction. This makes it possible to change an incident position of light on the template duplicate 2. The operation of the XY stage 23 is controlled by the stage controlling circuit 28. After the light incident on the template duplicate 2 is transmitted through the template duplicate 2, it is incident on the image sensor 25 through the objective lens 24.

The image sensor 25 is a charge coupled device (CCD) sensor, for example. The image sensor 25 can acquire a pattern image of the second roughness pattern P₂ by imaging the template duplicate 2 on the XY stage 23. The pattern image of the second roughness pattern P₂ is enlarged by an optical system including the condenser lens 22, the objective lens 24 and the like to be focused on the image sensor 25.

The image sensor 25 outputs the acquired pattern image to the sensor circuit 26. The sensor circuit 26 generates an optical image (sensor image) of the second roughness pattern P₂ from the pattern image, and outputs the sensor image to the A/D converter 27. The A/D converter 27 converts the sensor image from an analog signal to a digital signal, and outputs the converted sensor image to the calculator 29 and the defect detecting circuit 30.

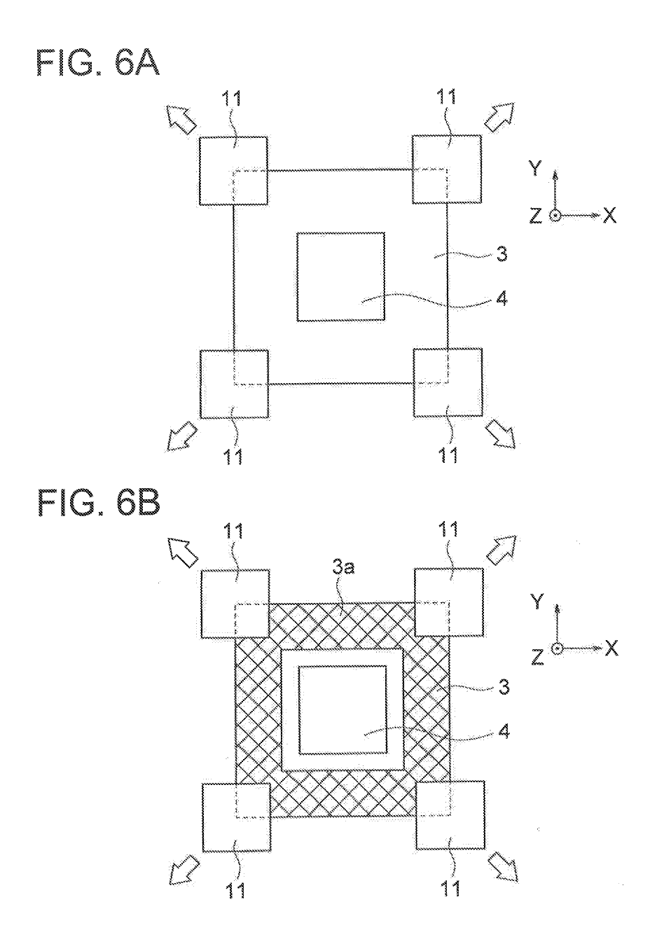

The calculator 29 controls various kinds of operation of the template inspecting apparatus. For example, the calculator 29 controls operation of the stage controlling circuit 28 and the defect detecting circuit 30, based on the sensor image from the A/D converter 27. Thereby, the calculator 29 can control the incident position of the light on the template duplicate 2 and detection processing of the defect by the defect detecting circuit 30. Details of the defect detecting circuit 30 are described with reference to FIG. 8.

FIG. 8 is a flowchart illustrating a template inspecting method of the first embodiment.

First, the template duplicate 2 is produced from the template 1, and dimensions of the second roughness pattern P₂ before enlargement are measured (step S1). For example, a width of the convex portions 2a or the concave portions 2b before the enlargement is measured. The dimensions of the second roughness pattern P₂ before the enlargement may be measured by the template inspecting apparatus in FIG. 7 or may be measured by another apparatus. In the latter case, the measured dimensions are transferred to the template inspecting apparatus.

Next, the template duplicate 2 is enlarged (step S2). The template duplicate 2 may be enlarged by the stretching like the template producing method described above or may be enlarged by another method. For example, the template duplicate 2 may be enlarged by swelling.

Next, the template duplicate 2 is put on the XY stage 23, and dimensions of the second roughness pattern P₂ after the enlargement are measured (step S3). For example, a width of the convex portions 2a or the concave portions 2b after enlargement is measured. The dimensions of the second roughness pattern P₂ after the enlargement are measured by the defect detecting circuit by using the sensor image.

Next, the defect detecting circuit 30 calculates a magnification of the template duplicate 2 by using the dimensions measured in step S1 and the dimensions measured in step S3 (step S4). This magnification corresponds to a magnification of the second roughness pattern P₂ relative to the first roughness pattern P₁. For example, when the magnification is 150%, this means that the defect R₁ of 20 nm is enlarged to the defect R₂ of nm. The defect detecting circuit 30 may separately calculate the magnification in the X direction and the magnification in the Y direction.

Next, the defect detecting circuit 30 detects the defect R₂ of the template duplicate 2 by using the sensor image (step S5). The defect detecting circuit 30 preliminarily stores a reference image that is design data of the first roughness pattern P₁. The defect detecting circuit 30 can detect the defect R₂ by matching the sensor image with the reference image. At this time, the defect detecting circuit 30 detects a position (coordinates) and a shape of the defect R₂. The defect detecting circuit 30 may further detect dimensions of the defect R₂.

Next, the defect detecting circuit 30 calculates the position and the shape of the defect R₁ of the template 1, based on the position of the defect R₂ of the template duplicate 2 and the magnification described above (step S6). In this way, the defect detecting circuit 30 can inspect the defect R₁ of the template 1 by using the template duplicate 2. The calculation results of the position and the shape of the defect R₁ are outputted to the outside of the template inspecting apparatus from the defect detecting circuit 30.

As described above, the substrate 6 that holds the shape of the template duplicate 2 is pasted on the enlarged template duplicate 2 in the present embodiment. This makes it possible to correct distortion of the template duplicate 2 and to secure the planarity of the template duplicate 2. If the planarity of the template duplicate 2 is poor, it causes problems that the light in FIG. 7 hardly focuses on the template duplicate 2 and large noise occurs in inspecting the template duplicate 2, for example.

According to the present embodiment, these problems can be suppressed by securing the planarity of the template duplicate 2, and defects can be inspected in high precision.

### Second Embodiment

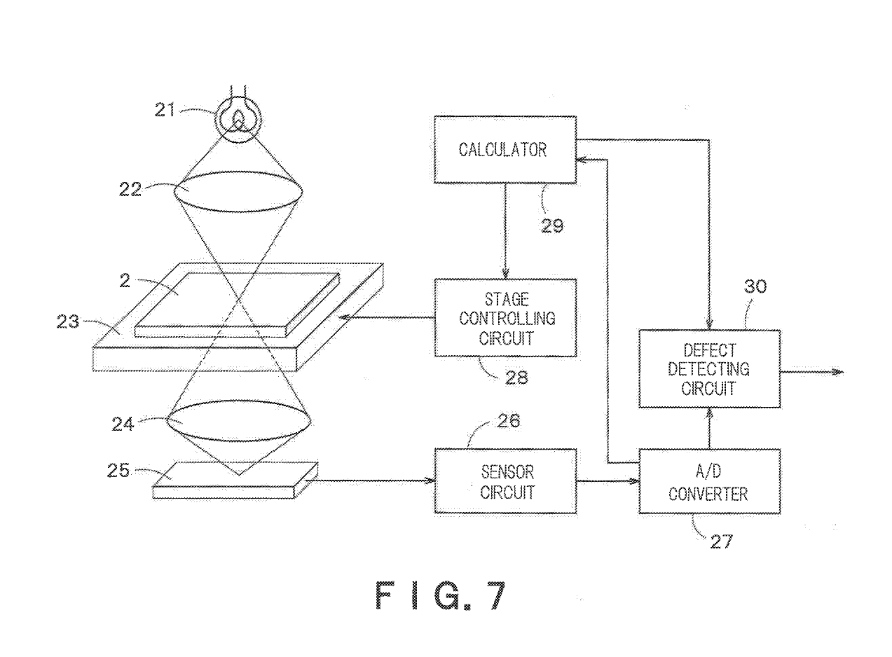

FIG. 9 is a cross-sectional view illustrating a structure of the template duplicate 2 of the first embodiment.

As described above, the template duplicate 2 of the first embodiment includes the resin film 3 and the resin material 4, and is bonded to the substrate 6 with the adhesive 5. In such a case, a scratch D₁ may be present on the resin film 3, and a particle D₂ may stick to the resin film 3. The scratch D₁ and the particle D₂ on the resin film 3 may increase noise in inspecting the template duplicate 2. The reason is that the scratch D₁ and the particle D₂ may be recognized as defects.

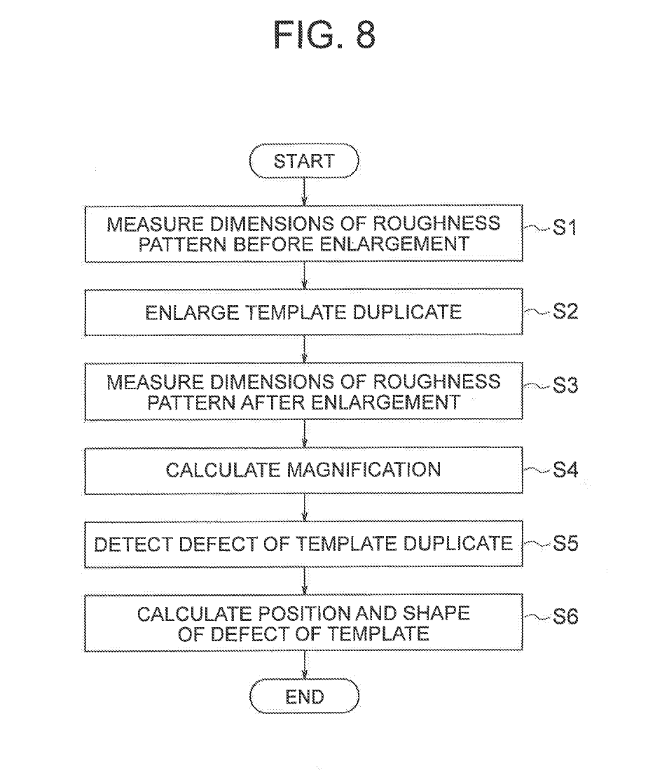

FIG. 10 is a cross-sectional view illustrating a structure of the template duplicate 2 of a second embodiment.

The template duplicate 2 of the second embodiment further includes a first flattening layer 8 formed on one surface of the resin film 3, and a second flattening layer 9 formed on the other surface of the resin film 3. The resin material 4 is pasted on the resin film 3 via the first flattening layer 8. The substrate 6 is bonded to the resin film 3 via the second flattening layer 9. The first and second flattening layers 8 and 9 of the present embodiment are formed of fluorine resin, similarly to the resin film 3. The resin material 4 is an example of the first layer. The resin film 3, the first flattening layer 8 and the second flattening layer 9 are an example of the second layer. The first flattening layer 8 is an example of a third layer. The second flattening layer 9 is an example of a fourth layer.

In the present embodiment, before the resin material 4 is supplied onto the resin film 3 in the step of FIG. 2A, the flattening layers 8 and 9 are formed on both surfaces of the resin film 3. This makes it possible to embed the scratch D₁ and the particle D₂ in the flattening layers 8 and 9, and to flatten the surfaces on which the resin material 4 and the substrate 6 are to be pasted. Therefore, according to the present embodiment, noise caused by the scratch D₁ and the particle D₂ can be reduced.

### Third Embodiment

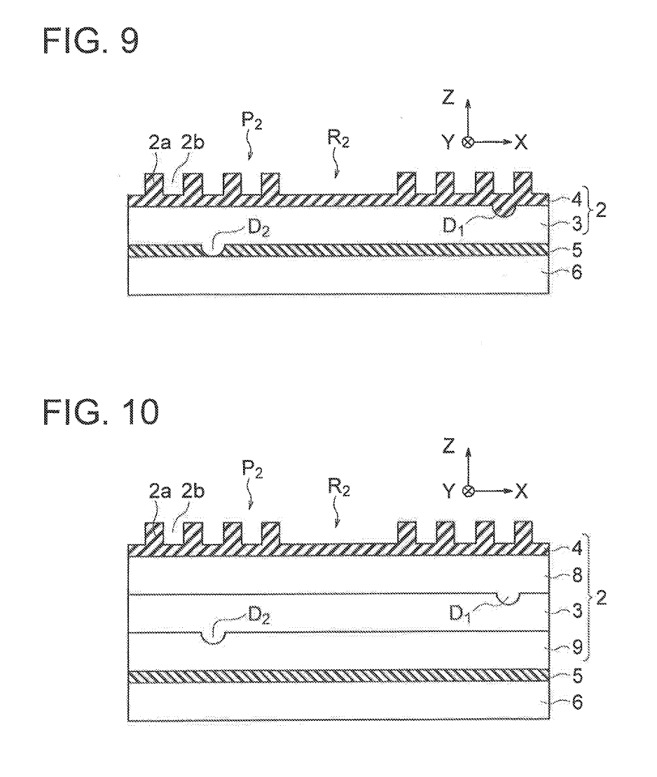

FIG. 11 is a graph for explaining the template duplicate 2 of a third embodiment.

As described above, the resin of the resin film 3 is fluorine resin, for example. In a case where the resin film 3 is liable to absorb ultraviolet rays, the resin film 3 is liable to be colored and deformed, which easily causes larger noise. Meanwhile, the fluorine resin has a property of hardly absorbing ultraviolet rays. For example, the fluorine resin hardly absorbs far ultraviolet rays with approximately 200 nm of wavelength which is often used in the template producing method described above. Therefore, the present embodiment makes it possible, by preparing the resin film 3 formed of fluorine resin, to reduce noise in inspecting the template duplicate 2.

FIG. 11 is a graph in which characteristics of various fluorine resins are compared. FIG. 11 illustrates characteristics of PFA (copolymer of tetrafluoroethylene and perfluoroalkyl vinyl ether), ETFE (copolymer of tetrafluoroethylene and ethylene), FEP (copolymer of tetrafluoroethylene and hexafluoropropylene) and pellicle.

FIG. 11 illustrates adhesion characteristics between the fluorine resins and another material, stretching characteristics of the fluorine resins, and cleanliness characteristics of the fluorine resins. The circles in the graph indicate that the characteristics are excellent. The double circles in the graph indicate that the characteristics are further more excellent. According to FIG. 11, it is apparent that the characteristics of FEP are most excellent out of the four fluorine resins. Therefore, the resin film 3 of the present embodiment is desirable to be formed of FEP. Similarly, the first and second flattening layers 8 and 9 are also desirable to be formed of FEP.

### Fourth Embodiment

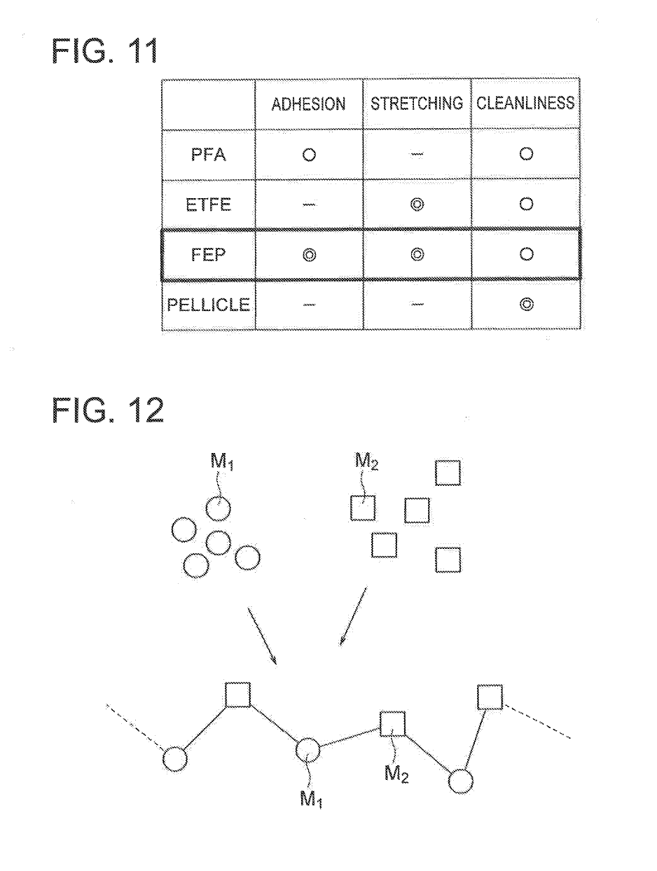

FIG. 12 is a schematic diagram for explaining the template duplicate 2 of a fourth embodiment.

The resin material 4 of the present embodiment before the curing contains monomers M₁ of vinyl compound, monomers M₂ of acryloyl compound, and an unshown polymerization initiator. When this resin material 4 is irradiated with ultraviolet rays, action of the polymerization initiator causes the monomers M₁ and M₂ to polymerize. As a result, the resin material 4 of the present embodiment after the curing contains a polymer including the monomers M₁ (vinyl groups) and the monomers M₂ (acryloyl groups). This polymer is a copolymer including the two kinds of monomers M₁ and M₂.

For example, in a case where the resin material 4 is formed of a polymer including only the acryloyl groups, the resin material 4 suffers breakage when the magnification of the second roughness pattern P₂ becomes approximately 110%.

On the other hand, the resin material 4 of the present embodiment is formed of a polymer in which a composition ratio between the vinyl groups and the acryloyl groups is 1:1. In this case, the resin material 4 can be enlarged such that the magnification becomes 200% or more. According to an experiment, the resin material 4 in this case was able to be enlarged without breakage until the magnification becomes approximately 300%. Therefore, the polymer of the resin material 4 of the present embodiment is desirable to include the vinyl groups.

The composition ratio between the vinyl groups and the acryloyl groups may be other than 1:1. Moreover, the polymer of the resin material 4 may include only the vinyl groups in place of Including the vinyl groups and the acryloyl groups. According to an experiment, the resin material 4 in this case was able to be enlarged without breakage until the magnification becomes approximately 500%. Moreover, the polymer of the resin material 4 may include the vinyl groups and functional groups other than the acryloyl groups.

While certain embodiments have been described, these embodiments have been presented by way of example only, and are not intended to limit the scope of the inventions. Indeed, the novel methods and apparatuses described herein may be embodied in a variety of other forms; furthermore, various omissions, substitutions and changes in the form of the methods and apparatuses described herein may be made without departing from the spirit of the inventions. The accompanying claims and their equivalents are intended to cover such forms or modifications as would fall within the scope and spirit of the Inventions.

1. A template producing method comprising:
coating a first template having a first pattern with a curable material;
curing the material;
producing a second template having a second pattern corresponding to the first pattern by peeling the cured material from the first template;
enlarging the second template; and
pasting, on the enlarged second template, a substrate that holds a shape of the second template.

2. The method of claim 1, wherein the second template comprises a first layer including the cured material, and a second layer formed of a material different from a material of the first layer.

3. The method of claim 2, wherein the second layer contains fluorine resin.

4. The method of claim 3, wherein the fluorine resin contains FEP (copolymer of tetrafluoroethylene and hexafluoropropylene).

5. The method of claim 2, wherein the second layer includes a resin film, a third layer formed on a first surface of the resin film, and a fourth layer formed on a second surface of the resin film.

6. The method of claim 5, wherein the third and fourth layers are formed of resin.

7. The method of claim 2, wherein the first layer contains a polymer including a vinyl group.

8. The method of claim 7, wherein the polymer includes the vinyl group and an acryloyl group.

9. The method of claim 1, wherein the second template is enlarged such that a magnification of the second template becomes 200% or more.

10. The method of claim 1, wherein the substrate is formed of glass or quartz.

11. The method of claim 1, further comprising trimming an extra portion of the second template after the substrate is pasted on the second template.

12. The method of claim 1, further comprising pasting, on a blank, the substrate on which the second template is pasted.

13. A template producing apparatus comprising:
an enlarging module configured to enlarge a second template having a second pattern corresponding to a first pattern of a first template; and
a pasting module configured to paste, on the enlarged second template, a substrate that holds a shape of the second template.

14. The apparatus of claim 13, further comprising a template producing module configured to coat the first template with a curable material, cure the material, and produce the second template by peeling the cured material from the first template.

15. The apparatus of claim 13, further comprising a trimming module configured to trim an extra portion of the second template after the substrate is pasted on the second template.

16. The apparatus of claim 13, wherein the second template is enlarged such that a magnification of the second template becomes 200% or more.

17. The apparatus of claim 13, wherein the enlarging module comprises first, second, third and fourth retaining modules configured to respectively retain first, second, third and fourth corners of the second template and to move so as to enlarge the second template.

18. The apparatus of claim 13, wherein the second template comprises a first layer including the cured material, and a second layer formed of a material different from a material of the first layer.

19. A template inspecting apparatus comprising:
a retaining module configured to retain a second template on which a substrate is pasted, the second template having a second pattern corresponding to a first pattern of a first template;
an imaging module configured to image the second template retained by the retaining module to acquire an image of the second pattern;
a magnification calculating module configured to calculate a magnification of the second pattern relative to the first pattern, based on the Image;
a defect detecting module configured to detect a defect of the second template, based on the image; and
a defect position calculating module configured to calculate a position of a defect of the first template, based on a position of the defect of the second template and the magnification.

20. The apparatus of claim 19, wherein the second template comprises a first layer including the cured material, and a second layer formed of a material different from a material of the first layer.
